(19) United States
(12) Patent Application Publication
(10) Pub. No.: US 2025/0328468 A1
(43) Pub. Date: Oct. 23, 2025

(54) CONTROLLER AND METHOD FOR COPYING DATA FROM PROCESSING UNIT TO MEMORY SYSTEM

(71) Applicant: Huawei Cloud Computing Technologies Co., Ltd., Gui‘an New District (CN)

(72) Inventor: Maciej Maciejewski, Warsaw (PL)

(73) Assignee: Huawei Cloud Computing Technologies Co., Ltd., Gui‘an New District (CN)

(21) Appl. No.: 19/202,951

(22) Filed: May 8, 2025

Related U.S. Application Data
(63) Continuation of application No. PCT/EP2022/081104, filed on Nov. 8, 2022.

(51) Int. Cl. G06F 12/06; G06F 5/01; G06F 12/02

(52) U.S. Cl. CPC G06F 12/0607; G06F 5/01; G06F 12/0246

(57) ABSTRACT

A controller is provided to copy data from a processing unit to a memory system, wherein the processing unit includes a volatile memory and the memory system includes a persistent memory, wherein the controller includes a memory address decoding module that is configured to receive a first address from the processing unit, the first address is a physical address for the data to be copied to as utilized by the processing unit. The memory address decoding module is further configured to translate the first address into a second address taking into account interleaving settings and granularity of the persistent memory, wherein the second address is a shifted version of the first address, and is for the persistent memory and provide the second address to a memory controller of the memory system. The controller reduces the latency during data movement from the processing unit to the persistent memory devices.

### CROSS-REFERENCE TO RELATED APPLICATIONS

This application is a continuation of International Application No. PCT/EP2022/081104, filed on Nov. 8, 2022, the disclosure of which is hereby incorporated by reference in its entirety.

### TECHNICAL FIELD

Embodiments of this application relate to the field of data management; and more specifically, to a controller and a method for copying data from a processing unit to a memory system.

### BACKGROUND

Typically, copying of data from a central processing unit (CPU) to a memory sub-system is processed by the CPU internals, including cache mechanisms and memory controller modules. Each CPU socket can contain multiple memory controllers and each of the memory controllers may have multiple memory channels, and ranks with memory devices attached to the memory controllers. In this arrangement of the CPU and the memory devices, the physical memory address ranges of each memory device are combined within interleave sets (IS) and processed with source address decoder (SAD) and target address decoder (TAD) registers of the CPU. The interleave set granularity depends on built-in addressing scheme of the CPU. The values of built-in addressing scheme in modern CPUs include 4 kB/16 kB size. Such addressing scheme causes all objects smaller than the interleave set granularity (e.g., 4 kB in a page alignment scenario) to be stored on a single memory device. The spreading of data across multiple memory devices is performed only when size of the objects is larger than the interleave set granularity. The persistent storage of objects smaller than the interleave set granularity results in an underutilization of the number of memory devices which further leads to performance degradation. This is caused due to nature of non-volatile dual in-line memory module (NVDIMM) devices operating with error correction code (ECC) block size granularity, which is typically 256 bytes. Therefore, storage of 2 kB object results in 8 write cycles to the memory devices (i.e., media). Such limitation is not observable with regular dynamic random-access memory (DRAM), as all the writes are buffered either on the CPU cache side or within the memory controller (MC) buffers. In case of persistent memory, these writes cannot be buffered. The reason being an application relies on safe storage of the data on the medium (i.e., storage medium) and waits until the appropriate memory barrier is released.

Currently, certain efforts are made in order to ensure data persistency while moving the data from a CPU to a persistent memory device(s), such as execution of certain instructions in a proper order. For example, applications using persistent memory (PMEM/NVDIMM/SCM) for safe object storage are required to ensure reliable data transfer to persistency domain, sometimes referred to as power-fail safe domain. This is performed by usage of memory copy operation followed by cache flush operation and memory barrier. Only after execution of the memory barrier instruction, the code is executed. In case of small objects, this approach is bottlenecked by the performance of single persistent memory device. The execution of 2 kB write is performed with bandwidth and latency profile of the single persistent memory device either due to large granularity of the CPU addressing scheme or due to mismatch in granularity between CPU interleave sets and the ECC block size of memory devices. Thus, there exists a technical problem of a mismatch between CPU addressing scheme and granularity of persistent memory devices which further leads to an increase in latency during data movement from the CPU to the persistent memory devices.

Therefore, in light of the foregoing discussion, there exists a need to overcome the aforementioned drawbacks associated with the conventional ways of ensuring data persistency while moving data from the CPU to the persistent memory device(s).

### SUMMARY

Embodiments of this application provide a controller and a method for copying data from a processing unit to a memory system. The embodiments of this application provides a solution to the existing problem of a mismatch between CPU addressing scheme and granularity of persistent memory devices which further leads to an increase in latency during data movement from the CPU to the persistent memory devices. An aim of the present disclosure is to provide a solution that overcomes at least partially the problems encountered in prior art, and provide an improved controller and an improved method for copying data from a processing unit to a memory system.

In one aspect, the present disclosure provides a controller configured to copy data from a processing unit to a memory system, where the processing unit comprises a volatile memory and where the memory system comprises a persistent memory, where the controller comprises a memory address decoding module that is configured to receive a first address from the processing unit, the first address being a physical address for the data to be copied to as utilized by the processing unit. The memory address decoding module is further configured to translate the first address into a second address taking into account interleaving settings and granularity (ECC) of the persistent memory, where the second address is a shifted version of the first address, and is for the persistent memory and provide the second address to a memory controller of the memory system.

The disclosed controller bridges the gap between addressing capabilities of the processing unit (e.g., CPU) and granularity of the persistent memory devices which further reduces the latency during data movement from the processing unit to the persistent memory devices. The controller is configured to decode the physical address of the data which is to be copied from the processing unit to the persistent memory of the memory system into the shifted physical address. Thus, the controller ensures persistent storage of data and spreads the data between multiple persistent memory devices. This further speed up the data distribution to the multiple persistent memory devices.

In an implementation form, the first address is based on a first interleaving, where the translation of the first address into the second address includes a second interleaving.

The use of the second interleaving during translation of the first address into the second address results into compatibility of the addressing schemes of the volatile memory and the persistent memory.

In a further implementation form, the interleaving settings includes granularity (IS) and number of devices (N).

By virtue of including the granularity and number of devices in the interleaving settings, the data can be distributed among multiple persistent memory devices.

In a further implementation form, the memory address decoding module is further configured to translate the first address (X) into the second address (f(X)) according to

$$f ( X ) = ( X mod ECC ) + ( ( X / ECC ) mod N ) * IS + ( X / ( ECC * N ) ) * ECC$$

This is advantageous to translate the first address into the second address according to aforementioned mathematical formula in order to achieve accuracy.

In a further implementation form, the data to be copied has a size smaller than the interleaving granularity.

In a further implementation form, the granularity of the volatile memory is different from the granularity of the persistent memory.

In a further implementation form, a memory addressing scheme of the volatile memory is different from a memory addressing scheme of the persistent memory.

The controller bridges the gap between the memory addressing schemes of the volatile memory and the persistent memory.

In a further implementation form, the controller is comprised in a Cache and Homing Agent, CPU CHA.

In a further implementation form, the controller is comprised in a Core Memory Controller.

In another aspect, the present disclosure provides a method for copying data from a processing unit to a memory system, where the processing unit comprises a volatile memory and where the memory system comprises a persistent memory, where the method comprises
receiving a first address from the processing unit, the first address being a physical address for the data to be copied to as utilized by the processing unit. The method further comprises translating the first address into a second address taking into account interleaving settings and granularity (ECC) of the persistent memory, where the second address is a shifted version of the first address, and is for the persistent memory. The method further comprises providing the second address to a memory controller of the memory system.

The method achieves all the advantages and technical effects of the controller of the present disclosure.

In a yet another aspect, the present disclosure provides a computer program product comprising program instructions for performing the method, when executed by one or more processors in a controller.

The one or more processors in the controller achieves all the advantages and effects of the method after execution of the method.

It is to be appreciated that all the aforementioned implementation forms can be combined.

It has to be noted that all devices, elements, circuitry, units and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of embodiments, a functionality or step to be performed by external entities is not reflected in the description of a detailed element of that entity which performs that step or functionality, it should be clear for a skilled person that these methods and functionalities can be implemented in respective software or hardware elements, or any kind of combination thereof. It will be appreciated that features of the present disclosure are susceptible to being combined in various combinations without departing from the scope of the present disclosure as defined by the appended claims.

Additional aspects, advantages, features and objects of the present disclosure would be made apparent from the drawings and the detailed description of the illustrative implementations construed in conjunction with the appended claims that follow.

### BRIEF DESCRIPTION OF THE DRAWINGS

The summary above, as well as the following detailed description of illustrative embodiments, is better understood when read in conjunction with the appended drawings. For the purpose of illustrating the present disclosure, constructions of the disclosure are shown in the drawings. However, the present disclosure is not limited to methods and instrumentalities disclosed herein. Moreover, those skilled in the art will understand that the drawings are not to scale. Wherever possible, like elements have been indicated by identical numbers.

Embodiments of the present disclosure will now be described, by way of example only, with reference to the following diagrams wherein:

FIG. 1 is a block diagram that illustrates movement of data from a processing unit to a memory system by use of a controller, in accordance with an embodiment of the present disclosure;

FIG. 2 is an implementation scenario of a controller, in accordance with an embodiment of the present disclosure;

FIG. 3A is an illustration of data movement from a processing unit to a number of persistent memory devices, in accordance with an embodiment of the present disclosure;

FIG. 3B is an illustration of data movement from a processing unit to a number of persistent memory devices, in accordance with another embodiment of the present disclosure;

FIG. 3C is an illustration of data movement from a processing unit to a number of persistent memory devices, in accordance with yet another embodiment of the present disclosure;

FIG. 4 is an implementation scenario of an address translation of data, in accordance with an embodiment of the present disclosure;

FIG. 5 is a graphical representation that depicts variation of data write latency to a persistent memory device, in accordance with an embodiment of the present disclosure;

FIG. 6 is a system representation comprising a processing unit and a plurality of persistent memory devices, in accordance with an embodiment of the present disclosure; and

FIG. 7 is a flowchart of a method for copying data from a processing unit to a memory system, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

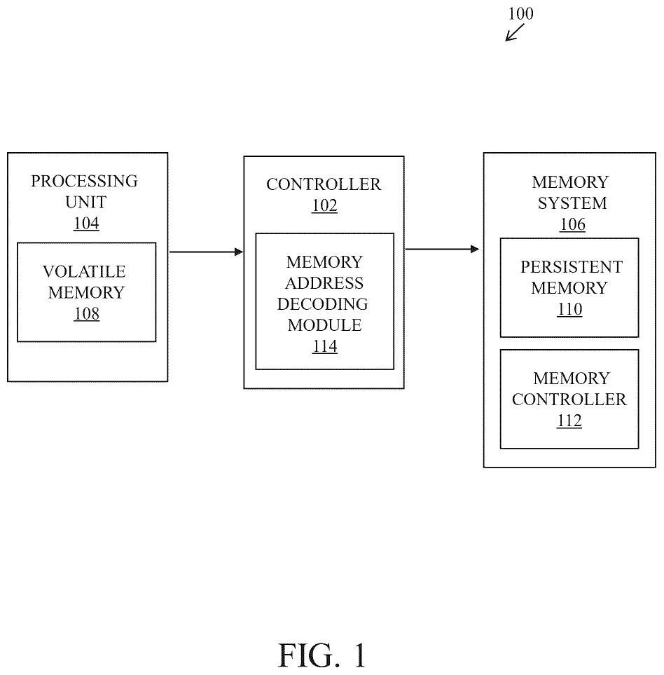

FIG. 1 is a block diagram that illustrates movement of data from a processing unit to a memory system by use of a controller, in accordance with an embodiment of the present disclosure. With reference to FIG. 1, there is shown a block diagram 100 that illustrates a controller 102 configured to copy data from a processing unit 104 to a memory system 106. The processing unit 104 comprises a volatile memory 108 and the memory system comprises a persistent memory 110 and a memory controller 112. The controller 102 comprises a memory address decoding module 114.

The controller 102 may include suitable logic, circuitry, and/or interfaces that is configured to copy data from the processing unit 104 to the memory system 106. In an implementation, the controller 102 may be configured to execute the instructions stored in the memory system 106. Examples of the controller 102 may include, but are not limited to, a microcontroller, a microprocessor, a complex instruction set computing (CISC) processor, an application-specific integrated circuit (ASIC) processor, a reduced instruction set (RISC) processor, a very long instruction word (VLIW) processor, a data processing unit, and other processors or control circuitry. Moreover, the controller 102 may refer to one or more individual processors, depending on an application scenario. In an implementation, the controller 102 may be comprised by the processing unit 104.

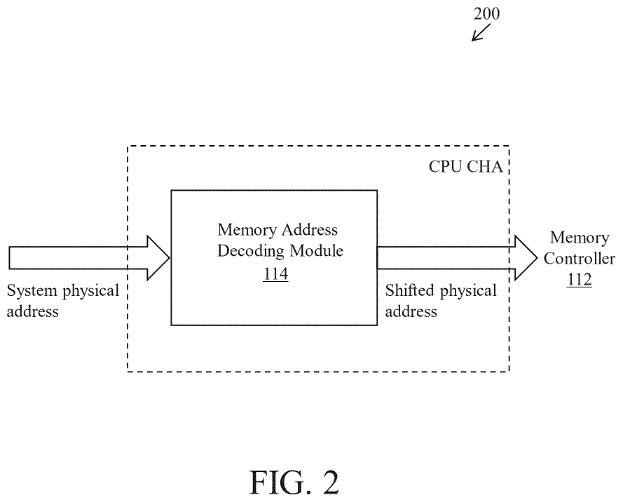

The processing unit 104 may include suitable logic, circuitry, and/or interfaces that is configured to have multiple cores, described in detail, for example, in FIG. 2A. The processing unit 104 may also be referred to as a central processing unit (CPU). In an implementation, the processing unit 104 may refer to one or more processing devices.

The memory system 106 may include suitable logic, circuitry, and/or interfaces that is configured to store data and the instructions executable by either the controller 102 or the processing unit 104.

The volatile memory 108 may include suitable logic, circuitry, and/or interfaces that is configured to store data and instructions executable by the processing unit 104. Examples of implementation of the volatile memory 108 may include, but are not limited to, an Electrically Erasable Programmable Read-Only Memory (EEPROM), Random Access Memory (RAM), Read Only Memory (ROM), Hard Disk Drive (HDD), Flash memory, Solid-State Drive (SSD), or CPU cache memory. The volatile memory 108 may store an operating system or other program products (including one or more operation algorithms) to operate a computing device.

The persistent memory 110 may include suitable logic, circuitry, and/or interfaces that is configured to store data structures such that the stored data structures can continue to be accessed using memory instructions or memory application programming interface (APIs) even after the end of a process that created or last modified the data structures. The persistent memory 110 is like a regular memory but it is persistent across server crashes, like hard disk or solid-state drive (SSD). However, the persistent memory 110 is byte-addressable like regular memory and can be accessed using remote direct memory access (RDMA). The use of the persistent memory 110 provides a fast access to the data stored in it.

In operation, the controller 102 is configured to copy data from the processing unit 104 to the memory system 106, where the processing unit 104 comprises the volatile memory 108 and where the memory system 106 comprises the persistent memory 110, where the controller 102 comprises the memory address decoding module 114 that is configured to receive a first address from the processing unit 104, the first address being a physical address for the data to be copied to as utilized by the processing unit 104. The memory address decoding module 114 is configured to receive the first address of the data which is to be copied from the processing unit 104 to the persistent memory 110 of the memory system 106. The first address is the physical address of the data in the volatile memory 108 of the processing unit 104.

The memory address decoding module 114 is further configured to translate the first address into a second address taking into account interleaving settings and granularity (ECC) of the persistent memory 110, where the second address is a shifted version of the first address, and is for the persistent memory 110. The memory address decoding module 114 is configured to receive information about the interleaving settings of the processing unit 104 and granularity (e.g., error correction code, ECC, block size) of the persistent memory 110 in order to translate the first address into the second address. The second address is the shifted (or the decoded) version of the first address. Moreover, the second address may correspond to a physical address of the data which is copied from the processing unit 104 to the persistent memory 110 of the memory system 106.

The memory address decoding module 114 is further configured to provide the second address to the memory controller 112 of the memory system 106. The second address of the data is provided to the memory controller 112 of the memory system 106 for copying the data to the persistent memory 110 of the memory system 106.

In accordance with an embodiment, the first address is based on a first interleaving, where the translation of the first address into the second address includes a second interleaving. The first address is based on the first interleaving that corresponds to the interleave set of the processing unit 104. More specifically, the first interleaving corresponds to the interleave set (or granularity) of the volatile memory 108 of the processing unit 104. And, the translation of the first address into the second address includes the second interleaving that corresponds to the interleave set of the persistent memory 110.

In accordance with an embodiment, the granularity of the volatile memory 108 is different from the granularity of the persistent memory 110. The memory address decoding module 114 is configured to distinguish granularity of the volatile memory 108 (i.e., the volatile memory 108 region) from the granularity (or ECC block size) of the persistent memory 110 (i.e., the persistent memory 110 region). Alternatively stated, the memory address decoding module is configured to resolve mismatch of granularities between the volatile memory 108 of the processing unit 104 and the persistent memory 110 of the memory system 106 with the introduction of an additional layer of memory interleaving that bridges the gap between the addressing capabilities of the processing unit 104 and the granularity of the persistent memory 110.

In accordance with an embodiment, a memory addressing scheme of the volatile memory 108 is different from a memory addressing scheme of the persistent memory 110. The memory addressing scheme of the volatile memory 108 is different from the memory addressing scheme of the persistent memory 110. Thus, the memory address decoding module 114 is used to fill a gap between the memory addressing schemes of the volatile memory 108 and the persistent memory 110.

In accordance with an embodiment, the interleaving settings includes granularity (IS) and number of devices (N). The interleaving setting (i.e., the first interleaving and the second interleaving) includes granularities of the volatile memory 108 and the persistent memory 110 and the number of devices (N).

In accordance with an embodiment, the data to be copied has a size smaller than the interleaving granularity. The data which is to be copied from the volatile memory 108 to the persistent memory 110, has smaller size than the interleave granularity (i.e., ECC block size) of the persistent memory 110.

In accordance with an embodiment, the controller 102 is comprised in a Cache and Homing Agent, CPU CHA. In an implementation, the controller 102 may be comprised in the Cache and Homing Agent. Generally, a cache homing agent (CHA) is defined as a unit found inside the core tiles (i.e., the tiles of the controller 102) that maintains the cache coherency between tiles. The CHA is also used to interface with a converged/common mesh stop (CMS). The CMS is generally defined as a mesh stop station that facilitates the interface between a tile and the fabric.

In accordance with an embodiment, the controller 102 is comprised in a Core Memory Controller. In another implementation, the controller 102 may be comprised in the core memory controller.

Thus, the controller 102 bridges the gap between addressing capabilities of the processing unit 104 (i.e., CPU) and the granularity of the persistent memory devices (e.g., the persistent memory 110) which further reduces the latency during data movement from the processing unit 104 to the persistent memory devices (e.g., the persistent memory 110). The controller 102 is configured to decode the physical address of the data which is to be copied from the processing unit 104 to the persistent memory 110 of the memory system 106 into the shifted physical address. Thus, the controller 102 ensures persistent storage of data and spreads the data between multiple persistent memory devices. This further speed up the data distribution to the multiple persistent memory devices.

FIG. 2 is an implementation scenario of a controller, in accordance with an embodiment of the present disclosure. FIG. 2 is described in conjunction with elements from FIG. 1. With reference to FIG. 2, there is shown an implementation scenario 200 of the controller 102 (of FIG. 1).

In the implementation scenario 200, the controller 102 is comprised by a cache homing agent, CPU CHA. The memory address decoding module 114 is configured to distinguish the functionalities of the volatile memory 108 and the persistent memory 110. The memory address decoding module 114 is configured to receive the first address of the data which is to be copied from the processing unit 104 to the persistent memory 110. The first address of the data corresponds to the physical address in the processing unit 104. The memory address decoding module 114 is configured to decode the first address of the data into the second address which is a shifted physical address of the data copied to the persistent memory 110.

In accordance with an embodiment, the memory address decoding module 114 is further configured to translate the first address (X) into the second address (f(X)) according to Equation (1)

$$f ( X ) = ( X mod ECC ) + ( ( X / ECC ) mod N ) * IS + ( X / ( ECC * N ) ) * ECC \qquad ( 1 )$$

where X—the physical address
ECC—device write granularity (commonly ECC block size)
N—number of devices belonging to interleave set
IS—interleave set granularity
mod—modulo operation; /—division without remainder operation

In order to translate the first address into the second address, the memory address decoding module 114 takes various inputs, such as the interleave granularity (i.e., ECC block size) of the persistent memory 110, interleave set settings of the processing unit 104, and the address ranges of the persistent memory 110. The second address (i.e., the shifted physical address) of the data is provided to the memory controller 112 of the memory system 106. In this way, each access to the persistent memory 110 passes through the memory address decoding module 114 which is configured to spread the incoming data to the available persistent memory modules.

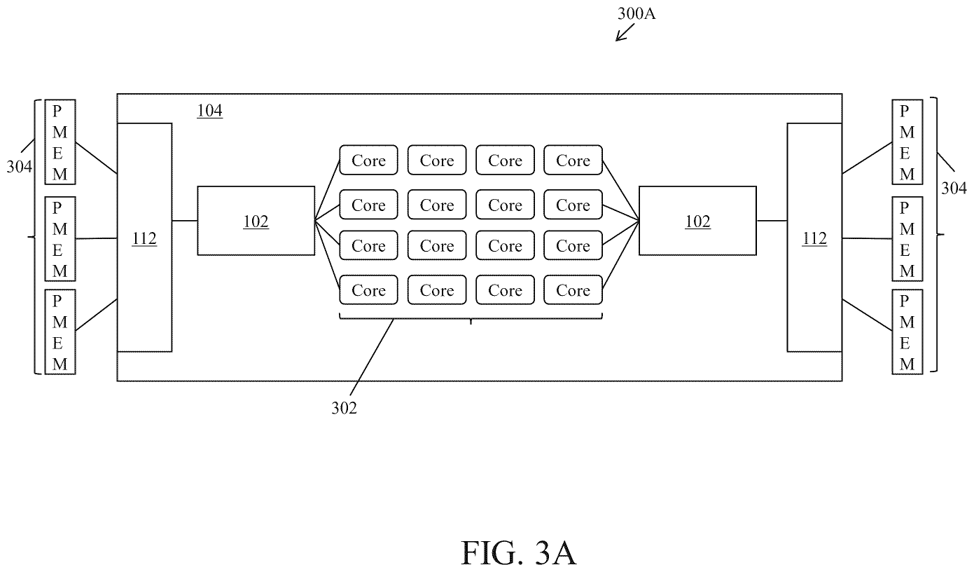

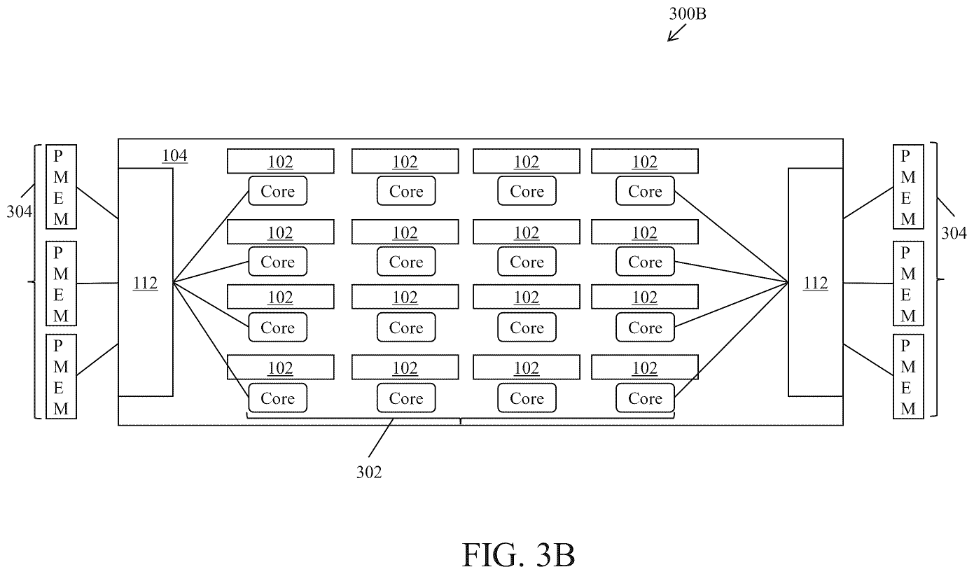

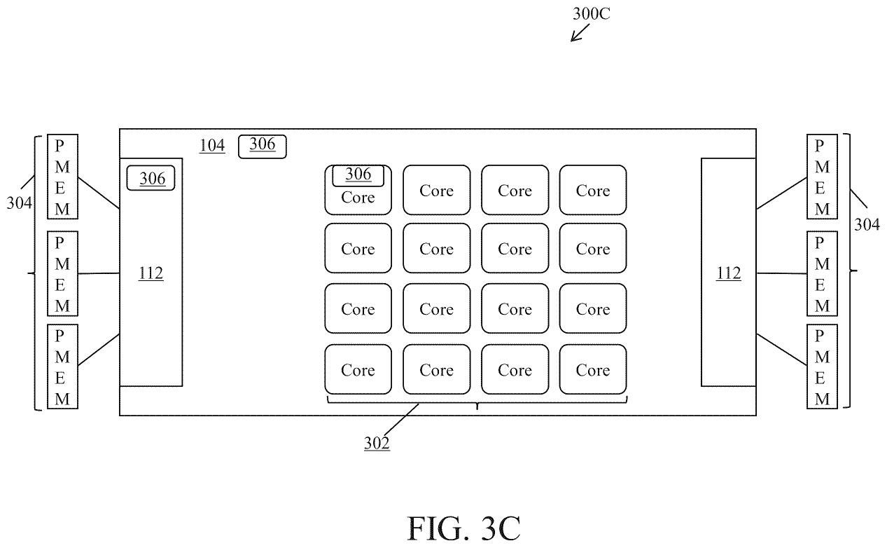

FIG. 3A is an illustration of data movement from a processing unit to a number of persistent memory devices, in accordance with an embodiment of the present disclosure. FIG. 3A is described in conjunction with elements from FIGS. 1 and 2. With reference to FIG. 3A, there is shown an illustration 300A that depicts the processing unit 104 comprising a plurality of cores 302. There is further shown the controller 102, the memory controller 112 (may also be represented as MC) and a plurality of persistent memory devices 304 (may also be represented as PMEM).

Each of the plurality of persistent memory devices 304 corresponds to the persistent memory 110 (of FIG. 1). The processing unit 104 comprising the plurality of cores 302 may also be stated as a central processing unit (CPU) comprising the plurality of cores 302. Each of the plurality of cores 302 may have a volatile memory (e.g., the volatile memory 108 of FIG. 1). In the illustration 300A, the controller 102 is associated with the plurality of cores 302 of the processing unit 104. Furthermore, the controller 102 is configured to copy the data from the plurality of cores 302 to the memory controller 112 and thereafter, to the plurality of persistent memory devices 304. In order to copy the data, the memory address decoding module 114 (not shown in FIG. 3A) of the controller 102 is configured to map the physical address of data which is to be copied from the plurality of cores 302 to the plurality of persistent memory devices 304 into the shifted physical address. The shifted physical address corresponds to the address of the data which is copied from the plurality of cores 302.

In another implementation, instead of the controller 102, the memory address decoding module 114 may be associated with the plurality of cores 302 of the processing unit 104 and may copy the data from the plurality of cores 302 to the plurality of persistent memory devices 304 by mapping the physical address of data.

FIG. 3B is an illustration of data movement from a processing unit to a number of persistent memory devices, in accordance with another embodiment of the present disclosure. FIG. 3B is described in conjunction with elements from FIGS. 1, 2, and 3A. With reference to FIG. 3B, there is shown an illustration 300B that depicts the processing unit 104 comprising the plurality of cores 302.

In the illustration 300B, the controller 102 is associated with each of the plurality of cores 302 of the processing unit 104. Furthermore, the controller 102 is configured to copy the data from each of the plurality of cores 302 to the plurality of persistent memory devices 304 by decoding the physical address of the data which is to be copied from each of the plurality of cores 302 to the plurality of persistent memory devices 304.

FIG. 3C is an illustration of data movement from a processing unit to a number of persistent memory devices, in accordance with yet another embodiment of the present disclosure. FIG. 3C is described in conjunction with elements from FIGS. 1, 2, 3A, and 3B. With reference to FIG. 3C, there is shown an illustration 300C that depicts the processing unit 104 comprising the plurality of cores 302. There is further an exclusive write section (EWS) 306 associated with the processing unit 104, each of the plurality of cores 302 and the memory controller 112.

In the illustration 300C, the EWS 306 is associated with each of the plurality of cores 302 of the processing unit 104. Furthermore, the EWS 306 is configured to copy the data from each of the plurality of cores 302 to the plurality of persistent memory devices 304 by decoding the physical address of the data which is to be copied from each of the plurality of cores 302 to the plurality of persistent memory devices 304.

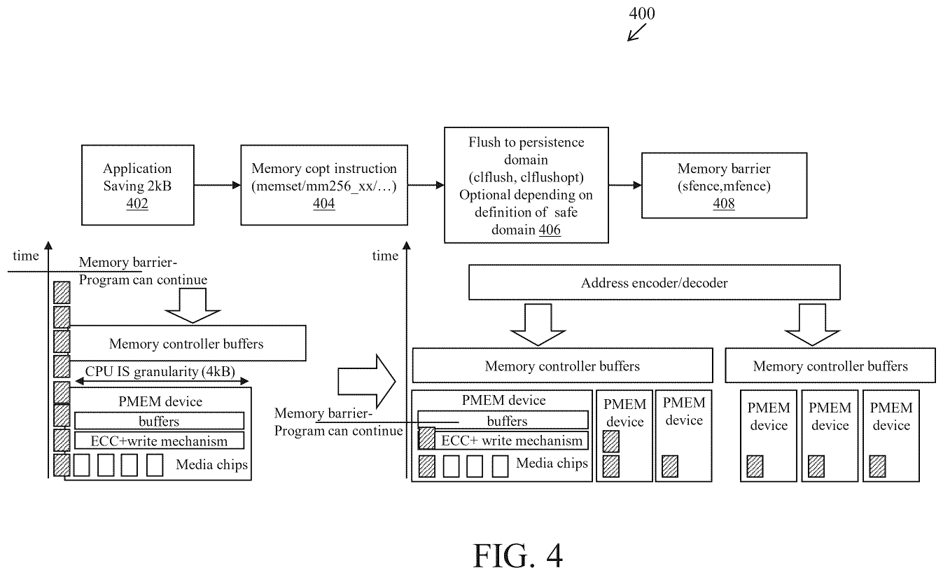

FIG. 4 is an implementation scenario of an address translation of data, in accordance with an embodiment of the present disclosure. FIG. 4 is described in conjunction with elements from FIGS. 1, 2, 3A, 3B, and 3C. With reference to FIG. 4, there is shown an implementation scenario 400 of address translation of data which is to be copied from the processing unit 104 to the memory system 106. The implementation scenario 400 includes operations 402 to 408.

At operation 402, an application saves one or more objects of size 2 kB.

At operation 404, the one or more objects of size 2 kB is copied using memory copy instruction (i.e., memset/mm256_xx/ . . . ).

At operation 406, the one or more objects of size 2 kB is copied from flush to persistent domain depending on definition of power fail safe domain (e.g., using an instruction clflush, clflushopt).

At operation 408, a memory barrier instruction is used (i.e., sfence, mfence, . . . ).

Conventionally, the operations 402 to 408 are carried out by use of sequential writes of ECC-size blocks, typically 256B. In the case of 2 kB write, the conventional approach takes 8 writes, each one of them takes around 600 ns with existing Optane persistent memory device. In contrast to the conventional approach, the proposed approach (i.e., the use of the controller 102 for copying data from the processing unit 104 to the memory system 106) distributed the write of one or more objects of size 2 kB across all available persistent memory (PMEM) devices. The same 2 kB object write can be achieved in 2 device write cycles with “×6” interleave, resulting in four times speed up. In this way, by virtue of use of memory address decoding functionality, the persistent storage of data is spread between multiple persistent memory devices. Thus, the memory addressing decoding functionality is applicable to systems equipped with persistent memory (e.g., the persistent memory 110) and enables the systems to have performance improvement for writes to the medium. The memory reads are potentially positively affected too.

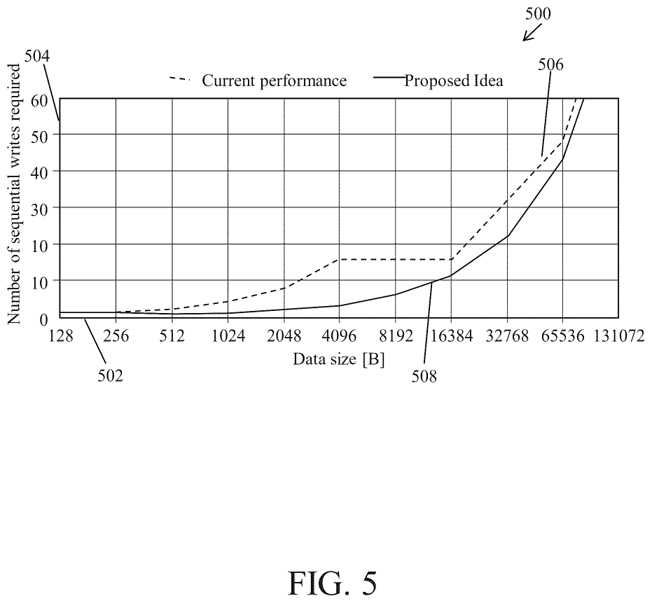

FIG. 5 is a graphical representation that depicts variation of data write latency to a persistent memory device, in accordance with an embodiment of the present disclosure. FIG. 5 is described in conjunction with elements from FIGS. 1, 2, 3A-3C, and 4. With reference to FIG. 5, there is shown a graphical representation 500 that depicts variation of data write latency to a persistent memory device (e.g., the persistent memory 110 of FIG. 1). The graphical representation 500 includes an X-axis 502 that represents size of data objects in bytes (B). The graphical representation 500 further includes a Y-axis 504 that represents number of sequential writes required.

In the graphical representation 500, a first curve 506 represents a conventional performance where no controller is used for data copying from a processing unit to a memory system. There is further shown a second curve 508 that represents performance of the proposed approach where the controller 102 is used for data copying from the processing unit 104 to the memory system 106 by mapping the physical address of the data which is to be copied from the volatile memory 108 of the processing unit 104 to the persistent memory 110 of the memory system 106. The second curve 508 has lower data write latency (i.e., improved one) in comparison to the first curve 506. The graphical representation 500 is obtained by considering the persistent memory topology consisting of six persistent memory devices, 256B ECC block size, 4 kB interleave set granularity.

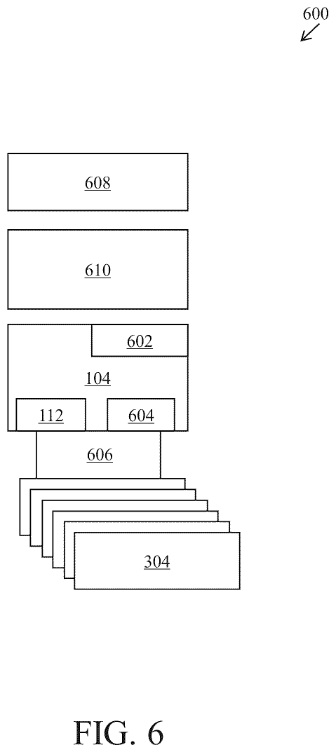

FIG. 6 is a system representation comprising a processing unit and a plurality of persistent memory devices, in accordance with an embodiment of the present disclosure. FIG. 6 is described in conjunction with elements from FIGS. 1, 2, 3A-3C, 4, and 5. With reference to FIG. 6, there is shown a system 600 that includes the processing unit 104 comprising a source address decoder (SAD)/target address decoder (TAD) register 602, and an input/output (I/O) unit 604. The processing unit 104 is attached with the memory controller (MC) 112 which is further connected to the plurality of persistent memory devices 304 through a compute express link (CXL) switch 606. There is further shown an application 608 and a persistent memory middleware library 610.

The application 608 provides contiguous chunks of data.

The persistent memory middleware library 610 is responsible for providing persistency assurance to data transfers. The persistent memory middleware library 610 may be implemented within individual applications. The persistent memory middleware library 610 may cause additional overhead for address computation.

The presence of the SAD/TAD register 602 and logic within cache homing agent (CHA) provides potentially an improved performance gain.

The system 600 is applicable only for the single CPU (i.e., the processing unit 104), with the plurality of persistent memory devices 304 connected through the memory controller 112. The plurality of persistent memory devices 304 may also be connected to the processing unit 104 either through the CXL switch 606 or through a double data rate (DDR) memory. An implementation scenario with multiple interconnected CPU sockets is also feasible in theory. Although, the implementation scenario with multiple interconnected CPU sockets is not applicable in practice due to other negative effects of crossing CPU boundary. For application scenarios, every application that relies on ensuring data persistency may use the system 600. Generally, in order to work with persistent memory devices, many applications use middleware software, for example, persistent memory development kit (PMDK). Such applications may use the system 600. Another application of the system 600 is logging functionality within databases.

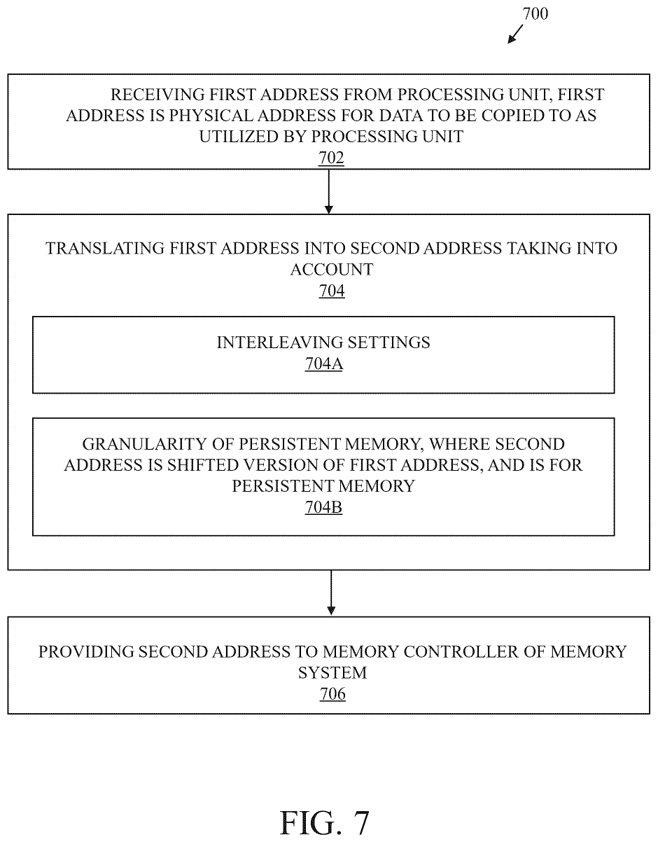

FIG. 7 is a flowchart of a method for copying data from a processing unit to a memory system, in accordance with an embodiment of the present disclosure. FIG. 7 is described in conjunction with elements from FIGS. 1, 2, 3A-3C, 4, 5, and 6. With reference to FIG. 7, there is shown a method 700 for copying data from the processing unit 104 to the memory system 106. The method 700 includes steps 702, 704, and 706. The step 704 includes two sub-steps 704A and 704B.

There is provided the method 700 for copying data from the processing unit 104 to the memory system 106. The processing unit 104 comprises the volatile memory 108 and the memory system 106 comprises the persistent memory 110. The method 700 is provided in order to bridge the gap between addressing capabilities of the processing unit 104 and granularity of the persistent memory devices (i.e., the persistent memory 110). The volatile memory 108 has different granularity from the granularity of the persistent memory 110. The method 700 is provided to bridge the gap between granularities of the volatile memory 108 and the persistent memory 110 in the following way.

At step 702, the method 700 comprises receiving a first address from the processing unit 104, the first address being a physical address for the data to be copied to as utilized by the processing unit 104. The first address corresponds to the physical address of the data which is to be copied from the volatile memory 108 of the processing unit 104 to the persistent memory 110 of the memory system 106.

At sub-step 704A of the step 704, the method 700 further comprises translating the first address into a second address taking into account interleaving settings. The first address is translated to the second address according to Equation (1), described in detail, for example, in FIG. 2. The translation of the first address into the second address includes the interleaving settings of the volatile memory 108 and of the persistent memory 110.

At sub-step 704B of the step 704, the method 700 further comprises translating the first address into the second address taking into account granularity (ECC) of the persistent memory 110, where the second address is a shifted version of the first address, and is for the persistent memory 110. The second address is the shifted (or the decoded) version of the first address. Moreover, the second address may correspond to a physical address of the data which is copied from the processing unit 104 to the persistent memory 110 of the memory system 106.

At step 706, the method 700 further comprises providing the second address to the memory controller 112 of the memory system 106. The second address of the data is provided to the memory controller 112 of the memory system 106 for copying the data to the persistent memory 110 of the memory system 106.

The steps 702 to 706 are only illustrative and other alternatives can also be provided where one or more steps are added, one or more steps are removed, or one or more steps are provided in a different sequence without departing from the scope of the claims herein.

In one aspect, there is provided a computer program comprising program instructions for performing the method 700, when executed by one or more processors in the controller 102. In another aspect, a computer system is provided comprising one or more processors in a controller (e.g., the controller 102) and one or more memories (e.g., the volatile memory 108 and the persistent memory 110), the one or more memories (i.e., the volatile memory 108 and the persistent memory 110) storing program instructions which, when executed by the one or more processors in the controller (i.e., the controller 102), cause the one or more processors in the controller (i.e., the controller 102) to execute the method 700. In yet another aspect, the present disclosure provides a non-transitory computer-readable medium having stored thereon, computer-implemented instructions that, when executed by a computer, causes the computer to execute operations of the method 700.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural. The word “optionally” is used herein to mean “is provided in some embodiments and not provided in other embodiments”. It is appreciated that certain features of the present disclosure, which are, for clarity, described in the context of separate embodiments, may also be provided in combination in a single embodiment. Conversely, various features of the present disclosure, which are, for brevity, described in the context of a single embodiment, may also be provided separately or in any suitable combination or as suitable in any other described embodiment of the disclosure.

1. A controller configured to copy data from a processor to a memory system, wherein the processor comprises a volatile memory and wherein the memory system comprises a persistent memory, wherein the controller-comprises a memory address decoder that is configured to:
receive a first address from the processor, wherein the first address is a physical address for the data to be copied to as utilized by the processor;
translate the first address into a second address taking into account
interleaving settings and
granularity of the persistent memory, wherein the second address is a shifted version of the first address, and is for the persistent memory; and
provide the second address to a memory controller of the memory system.

2. The controller according to claim 1, wherein the first address is based on a first interleaving, wherein the translation of the first address into the second address includes a second interleaving.

3. The controller according to claim 1, wherein the interleaving settings includes granularity and number of devices.

4. The controller according to claim 1, wherein the memory address decoder is further configured to:
translate the first address into the second address according to
$$f ( X ) = ( X mod ECC ) + ( ( X / ECC ) mod N ) * IS + ( X / ( ECC * N ) ) * ECC \underline{;}$$
wherein X represents the first address, f(X) represents the second address,
ECC represents device write granularity which is a commonly error correction code (ECC) block size, N is a quantity of devices belonging to an interleave set, IS represents interleave set granularity, and mod represents a modulo operation.

5. The controller according to claim 1, wherein the data to be copied has a size smaller than the interleaving granularity.

6. The controller according to claim 1, wherein the granularity of the volatile memory is different from the granularity of the persistent memory.

7. The controller according to claim 1, wherein a memory addressing scheme of the volatile memory is different from a memory addressing scheme of the persistent memory.

8. The controller according to claim 1, wherein the controller is comprised in a central processing unit Cache and Homing Agent (CPU CHA).

9. The controller according to claim 1, wherein the controller is comprised in a Core Memory Controller.

10. A method for copying data from a processor to a memory system, wherein the processor comprises a volatile memory and wherein the memory system comprises a persistent memory, wherein the method comprises
receiving a first address from the processor, wherein the first address is a physical address for the data to be copied to as utilized by the processor;
translating the first address into a second address taking into account
interleaving settings and
granularity of the persistent memory, wherein the second address is a shifted version of the first address, and is for the persistent memory; and
providing the second address to a memory controller of the memory system.

11. A computer program product comprising program instructions for performing the method according to claim 10, when executed by one or more processors in a controller.
